(19) United States
(12) Patent Application Publication
(10) Pub. No.: US 2026/0145573 A1
(43) Pub. Date: May 28, 2026

(54) IDENTIFYING INFORMATION SETTING APPARATUS AND PROGRAM

(71) Applicant: DENSO CORPORATION, Kariya-city (JP)

(72) Inventors: Yasuhito TANABE, Kariya-city (JP); Shinya Kato, Kariya-city (JP); Yoshiki Suzuki, Kariya-city (JP)

(73) Assignee: DENSO CORPORATION, Kariya-city (JP)

(21) Appl. No.: 19/177,757

(22) Filed: Apr. 14, 2025

Related U.S. Application Data
(63) Continuation of application No. PCT/JP2023/036597, filed on Oct. 6, 2023.

(30) Foreign Application Priority Data
Oct. 31, 2022 (JP) 2022-174597

(51) Int. Cl. B60L 58/10; B60L 3/00

(52) U.S. Cl. CPC B60L 58/10; B60L 3/0046

(57) ABSTRACT

A storage battery system includes a plurality of battery modules each of which is made up of a storage battery and a monitoring device which supervises the storage battery. An identifying information setting apparatus is communicable with the monitoring devices and works to set module identifying information about a module identification of each of the battery modules. The identifying information setting apparatus includes an installation determiner and an identifying information setting unit. The installation determiner is configured to determine whether each of the battery modules has been re-installed, which includes removal of a corresponding one of the battery modules and re-mounting thereof or exchanging with a replacement battery module in the storage battery system. The identifying information setting unit works to set the module identifying information for each of the battery modules when the battery module(s) is determined to have been re-installed.

### CROSS REFERENCE TO RELATED DOCUMENT

The present application claims the benefit of priority of Japanese Patent Application No. 2022-174597 filed on Oct. 31, 2022, the disclosure of which is incorporated in its entirety herein by reference.

### TECHNICAL FIELD

This disclosure generally relates to an identifying information setting apparatus and a program.

### BACKGROUND ART

Storage battery systems are known which include a plurality of battery modules (also called battery packs) and work to set identification numbers, one for each of the battery modules (e.g., a first Patent literature listed below). Identification formation about each of the battery modules is produced, for example, when the battery modules are installed in a vehicle in a production process of the vehicle.

### PRIOR ART DOCUMENT

### Patent Literature

FIRST PATENT LITERATURE: Japanese Patent No. 5735098

### SUMMARY OF THE INVENTION

Usually, a storage battery system for use in a vehicle is required to update or re-set identifying information (i.e., an identification) about each battery module upon replacement thereof. However, when a user or an operator of a vehicle replaces or exchange the battery modules with new or charged ones using known techniques, it may encounter a difficulty in resetting the identification of each of the battery modules. Similarly, when the battery modules are removed from the storage battery system, electrically recharged, and then re-installed in the storage battery system, it may face a difficulty in resetting the identifications of the battery modules. There is, therefore, room for improvement in resetting the identifications.

This disclosure was made in view of the above problem. It is an object of this disclosure to provide an identifying information setting apparatus designed to facilitate production of items of information on identification of battery modules upon replacement thereof and a program for use in producing or setting such identifiable information.

According to this disclosure, there is provided an identifying information setting apparatus for use in a storage battery system which includes a plurality of battery modules each of which has a battery and a monitoring device working to supervise the battery, the identifying information setting apparatus being capable of communicating with each of the monitoring devices and setting module identifying information for each of the battery modules. The identifying information setting apparatus comprises: (a) an installation determiner which is configured to determine whether each of the battery modules has been re-installed, which includes removal of a corresponding one of the battery modules and re-mounting thereof or exchanging with a replacement battery module in the storage battery system; and (b) an identifying information setting unit which is configured to set the module identifying information for each of the battery modules when at least one of the battery modules is determined by the installation determiner to have been re-installed.

The above-described structure is designed to determine whether each of the battery modules has been re-installed, which includes removal of a corresponding one of the battery modules and re-mounting thereof or exchanging with a replacement battery module in the storage battery system. The structure newly sets the module identifying information for the battery modules when the battery module(s) is determined to be re-installed in the storage battery system. The determination of whether the battery module(s) has been re-installed which is made by the identifying information setting apparatus facilitates the ease with which a identification setting mode to set the module identifying information is entered quickly after the installation of the battery modules. This makes it easy to produce the identification information for each of the battery modules upon re-installation or replacement of the battery modules.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a schematic view which illustrates a storage battery system;

FIGS. 2(a) and 2(b) are views which demonstrate electrical connections of battery modules;

FIG. 3 is a view which illustrates a plurality of battery modules installed in a vehicle;

FIG. 4 is a view which schematically illustrates a state of installation of each battery module in a rack of a vehicle;

FIGS. 5(a), 5(b), and 5(c) are views which demonstrate a sequence of steps to set identifications of battery modules;

FIG. 6 is a flowchart of a sequence of steps to set module identifications;

FIG. 7 is a flowchart of a sequence of steps to set a replacement record flag;

FIG. 8 is a flowchart of a sequence of steps to set module identifications in the second embodiment;

FIGS. 9(a) and 9(b) are flowcharts of sequences of steps to set replacement record flags in modifications;

FIG. 10 is a flowchart of a sequence of steps to set module identifications in another instance; and

FIG. 11 is a schematic view which illustrates an in-vehicle storage battery system and a battery storage system.

### MODE FOR CARRYING OUT THE INVENTION

Embodiments of this disclosure will be described below with reference to the drawings. Each embodiment will refer to a storage battery system installed in an electric-powered vehicle, such as an electrical automobile or a hybrid automobile. This disclosure is, however, not limited to the following embodiments, but may be modified without departing from the purpose of the disclosure. The same elements or equivalents thereof referred to in the embodiments will be denoted by the same or similar reference numbers or symbols, and explanation thereof in the embodiments refer to each other.

### First Embodiment

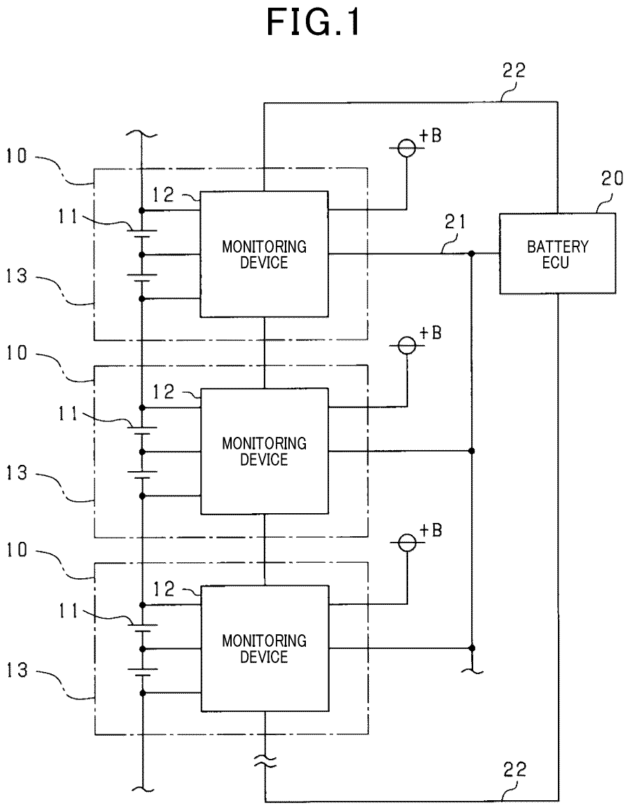

FIG. 1 is a view which schematically illustrates a structure of a storage battery system according to the first embodiment. The storage battery system includes a plurality of battery modules 10 and the battery ECU 20 working to control operations or conditions of the battery modules 10 which are mounted in a vehicle.

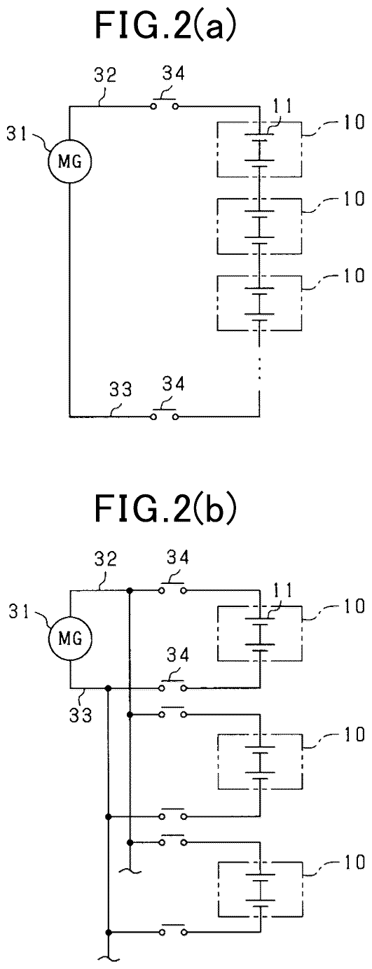

The battery modules 10 include the battery packs (also called assembled batteries or merely batteries) 11 each of which includes a plurality of electrical cells, the monitoring devices (also called supervising device) 12 which supervise conditions of the battery packs 11, and the housings 13 in which the battery packs 11 and the monitoring devices 12 are disposed. Each of the battery packs 11 is made of a secondary battery (i.e., an electrical accumulator), such as a lithium-ion battery. The battery pack 11 of each of the battery modules 10 is used as a power supply for the rotating electrical machine 31 working as a traction power source of the vehicle. The battery packs 11 of the battery modules 10 are, as illustrated in FIG. 2(a), electrically connected to the rotating electrical machine 31 in series therewith. More specifically, the rotating electrical machine 31 is equipped with an inverter working to control electrical current flowing in phase windings of the rotating electrical machine 31. The battery packs 11 are connected in series with each other in the form of a battery pack assembly which has a positive terminal and a negative terminal. The positive power supply wire 32 which extends from the positive terminal of the battery pack assembly is electrically connected to a positive side of the inverter. The negative power supply wire 33 which extends from the negative terminal of the battery pack assembly is electrically connected to a negative side of the inverter. Each of the power supply wires 32 and 33 has the power-supply switch 34 disposed therein. When the power-supply switches 34 are turned on, it establishes electrical connection between each of the battery packs 11 and the rotating electrical machine 31. The battery pack 11 of each of the battery modules 10 may alternatively be, as illustrated in FIG. 2(b), connected in parallel to the rotating electrical machine 31.

Each of the monitoring devices 12 is made of a microcomputer including a CPU and a variety of memories and works to measure or calculate a terminal-to-terminal voltage appearing at the cell(s), a discharge current, a temperature, a state-of-charge (SOC), and/or a state-of-health (SOH, i.e., battery degradation) of a corresponding one of the battery packs 11. Each of the monitoring devices 12 is used as a BMU (i.e., Battery Management Unit). Each of the monitoring devices 12 is connected to a low-voltage battery (+B), as illustrated in FIG. 1, so that it operates on power supplied from the low-voltage battery.

The battery ECU 20 is made of a microcomputer including a CPU and a variety of memories and connects with the monitoring devices 12 of the battery modules 10 using the communication line 21 which is capable of establishing a CAN (Controller Area Network). The battery ECU 20 works to perform a charge/discharge task for each of the battery modules 10 and tasks associated with an over-high temperature, a state of aging, and/or a communication failure of each of the battery modules 10 as needed. For instance, the battery ECU 20 analyzes information about the condition of each of the battery modules 10, as received from a corresponding one of the monitoring devices 12, to calculate a degree of electrical power which is chargeable to or dischargeable from the storage battery system and outputs a signal indicative thereof to an ECU installed in another vehicle. The battery ECU 20 also outputs a signal representing results of diagnosis of unusual or undesirable conditions, such as over-high temperatures, states of aging, and/or communication failures of the battery modules 10, to an ECU installed in another vehicle.

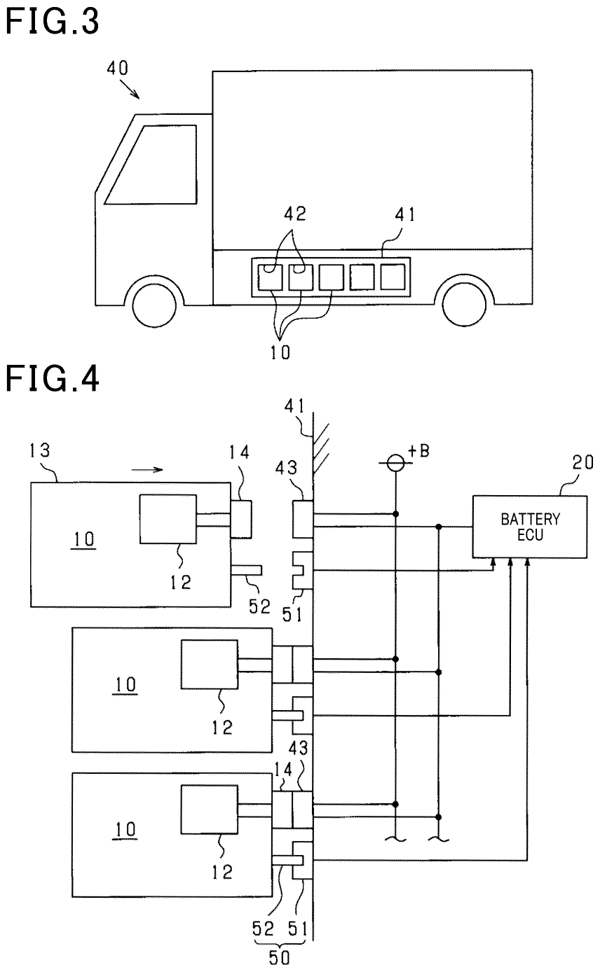

FIG. 3 schematically illustrates the vehicle 40 in which the battery modules 10 are installed.

The vehicle 40, as clearly illustrated in FIG. 3, has the rack (also called a frame) 41 serving as a module holder to which the battery modules 10 are secured. The rack 41 has a plurality of battery housings 42 in which the battery modules 10 are disposed. The vehicle 40 is designed to have the battery modules 10 removable therefrom or mountable therein by a user or a driver of the vehicle 10. For instance, the battery modules 10 may be independently removed from or mounted in the battery housings 41 through a side of the vehicle 40. In other words, it is possible to individually change out the battery modules 10.

The housing 13 for each of the battery modules 10, as illustrated in FIG. 4, has the module-connector 14 mounted thereon. The rack 41 has the rack-connectors 43 mounted thereon. The module-connectors 14 are connectable, one to each of the rack-connectors 43. When the battery modules 10 are attached to the rack 41, it establishes joints of the module-connectors 14 to the rack-connectors 43. The joints of the module-connectors 14 and the rack-connectors 43 enable the monitoring devices 12 and the battery ECU 20 to communicate with each other using the communication line 21. The monitoring devices 12 are supplied with electrical power from the battery (+B) through the joints of the module-connectors 14 and the rack-connectors 43. In other words, when the battery modules 10 are secured to the rack 41, it will cause power-supply voltage (i.e., +B voltage) to be applied to the monitoring devices 12, while when the battery modules 10 are removed from the rack 41, it will cause the supply of electrical power to the monitoring devices 12 to be cut. Each of the monitoring devices 12 is, therefore, actuated upon installation of a respective one of the battery modules 10 on the rack 41.

Although explanation using drawings is omitted here, in the battery modules 10 mounted in the rack 41, electrical power supply lines (e.g., the power supply wires 32 and 33 illustrated in FIG. 2) arranged in the vehicle 40 are electrically connected to the battery packs 11 of the battery modules 10. Electrical power supply connectors are preferably assembled along with, for example, the module-connector 14 and the rack-connector 43. The electrical power supply connectors establish a series-connection or a parallel-connection of the battery modules 10 in the vehicle 40.

The storage battery system in this embodiment is equipped with the locking devices 50 which tightly hold the battery modules 10 or make it difficult to remove the battery modules 10 from the rack 41 once the battery modules 10 are fastened to the locking devices 50. Each of the locking devices 50 includes locking members 51 and 52 secured to a corresponding one of the battery modules 10 and the rack 41. Each of the locking devices 50 works to output lock signals which are different from each other between a locked state and an unlocked state to the battery ECU 20. The battery ECU 20 analyzes the lock signal outputted from each of the locking devices 50 to determine whether a corresponding one of the locking devices 50 is currently in the locked state or the unlocked state.

The storage battery system is configured to set or produce identifying information for each of the battery modules 10, i.e., each of the monitoring devices 12 in the form of a module ID (i.e., a module identifier) and a communication ID (i.e., a communication identifier). The module IDs carry items of module identifying information. The communication IDs carry items of communication information. The identifying information for each of the battery modules 10 is stored both in a memory installed in the monitoring device 12 of a corresponding one of the battery modules 10 and in a memory installed in the battery ECU 20. The battery ECU 20 analyzes the identification information for each of the battery modules 10 to identify one of the battery modules 10 as a target to be controlled and also performs a charge/discharge control task and a diagnosis task for each of the battery modules 10 as needed. The battery ECU 20 receives the communication ID from the monitoring device 12 of each of the battery modules 10 using the communication line 21 and checks the received communication ID against the communication ID recognized by the battery ECU 20 to determine whether communication with a corresponding one of the monitoring devices 12 has been correctly established.

The identification information (i.e., the module ID and the communication ID) on each of the battery modules 10 is initialized prior to installation of the battery modules 10 in the vehicle 40 and then set after the battery modules 10 are installed in the vehicle 40. Usually, each of the battery modules 10 is replaced with a new or a charged one due to a reduction in amount of energy stored therein which is available to use or aging thereof, or removed temporarily from the vehicle 40 for being electrically charged by an external charger and then re-installed in the vehicle 40 after it is completely charged. In the case where one of the battery modules 10 is required to be replaced with a new or charged one (which will also be referred to below as a charged battery module(s) 10 or a replacement battery module(s) 10), the replacement battery module 10 whose identifying information is initialized is disposed in the vehicle 40. After the replacement battery module 10 is installed, the identifying information thereof is set. When shipped from the factory, all the battery modules 10 have common identifying information as default IDs.

When required to be electrically charged externally to the vehicle 40, the battery modules 10 are removed from the vehicle 40 and then installed in an external charger, for example, at a charging station. At this time, the identifying information is initialized in a corresponding one of the monitoring devices 12. In a case where each of the battery modules 10 is designed to be installed and used in the vehicle 40, the identification information may be initialized by the monitoring device 12 of each of the battery modules 10 when detecting the fact that a corresponding one of the battery modules 10 has been mounted in another device or equipment other than the vehicle 40. After installed in the vehicle 40, the identifying information for each of the battery modules 10 is determined or set.

The identifying information for each of the monitoring devices 12 may alternatively be initialized in response to disconnection of the connectors upon removal of a corresponding one of the battery modules 10 from the vehicle 40 (i.e., the rack 41).

The setting of the identifying information for each of the battery modules 10 is achieved in this embodiment using a PWM signal outputted from the battery ECU 20 to each of the monitoring devices 12. An example of a structure used for an ID setting task will be described below. The ID setting task is performed by the battery ECU 20 when it is required to replace one of the battery modules 10 with a new or charged one (i.e., the replacement battery module 10), and the replacement battery module 10 is installed in the vehicle 40. In this embodiment, the battery ECU 20 functions as an identifying information setting device.

Referring back to FIG. 1, the battery ECU 20 connects with the monitoring device 12 of each of the battery modules 10 through the PWM communication line 22. The PWM communication line 22 extends to connect the monitoring devices 12 of the battery modules 10 in series with each other. In the following discussion, the communication line 21 used for the CAN communication will also be referred to below as the CAN communication line 21 in order to discriminate it from the PWM communication line 22. The battery ECU 20 outputs the PWM signal having a given duty to a first one (which will also be referred to below as the first monitoring device 12) of the n monitoring devices 12 connected in series with each other and also receives the PWM signal from an n^{th} one (i.e., the last one which will also be referred to below as the n^{th} monitoring device 12) of the n monitoring devices 12.

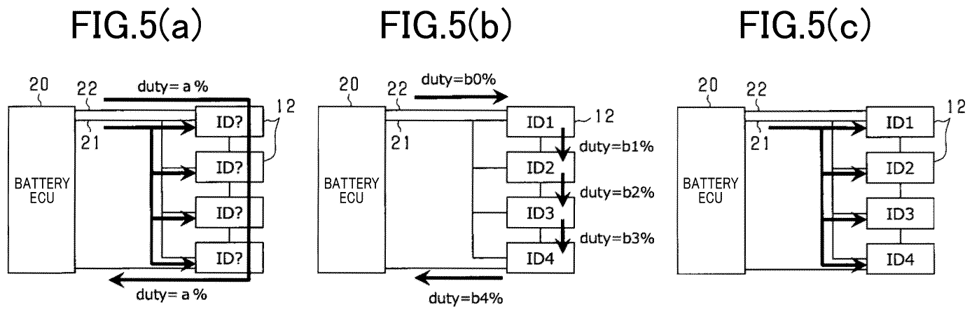

FIGS. 5(a), 5(b), and 5(c) are views which demonstrate a sequence of steps of the ID setting task in each of the battery modules 10. In an illustrated example, the number of the battery modules 10 is selected to be four for the brevity of explanation. The module IDs of the battery modules 10 are all set to default values. When all the battery modules 10 have been swapped or replaced with new or charged ones, the module IDs of all the replacement battery modules 10 are set to default values. When only one or a subset of the battery modules 10 has been replaced with a charged one(s) in the vehicle 40, so that the module ID(s) of the replacement battery module(s) 10 is a default value, the module IDs of all the battery modules 10 mounted in the vehicle 40 are initialized or set to default values.

In the initial step of the ID setting task illustrated in FIG. 5(a), the battery ECU 20 outputs ID setting requests to the monitoring devices 12 using the CAN communication line 21 to place each of the monitoring devices 12 in a standby state for setting IDs. The battery ECU 20 also outputs the PWM signal having a duty cycle a (i.e., a duty cycle of a %) using the PWM communication line 22. When receiving the PWM signal, each of the monitoring devices 12 which are placed in the standby states delivers the PWM signal as it is to an adjacent one located downstream in a series-connection arrangement of the monitoring devices 12. The last monitoring device 12, therefore, outputs the PWM signal having the duty cycle a to the battery ECU 20. The battery ECU 20 receives the PWM signal from the last monitoring device 12 and detects the fact that all the monitoring devices 12 are now placed in the standby states. The duty cycle a is set to, for example, 64%.

Afterwards, in the subsequent step of the DI setting task demonstrated in FIG. 5(b), the battery ECU 20 prepares a PWM signal for setting IDs and outputs it to the PWM communication line 22. Each of the monitoring devices 12 then alters a duty cycle of the PWM signal inputted thereto by a given value and transmits it to an adjacent one located downstream in the series-connection arrangement of the monitoring devices 12. Each of the monitoring devices 12 sets the module ID thereof based on the duty cycle of the PWM signal inputted thereto.

Each of the monitoring devices 12 woks to add or subtract a predetermined value to or from the duty cycle of the received PWM signal and outputs it as an output duty cycle to an adjacent one located downstream in the series-connection arrangement of the monitoring devices 12.

The duty cycle of the PWM signal prepared and outputted by the battery ECU 20 is set to b0%.

The first monitoring device 12 which receives the PWM signal directly from the ECU 20 outputs the PWM signal whose duty cycle is set to b1%.

The second monitoring device 12 which is located downstream of the first monitoring device 12 outputs the PWM signal whose duty cycle is set to b2%.

The third monitoring device 12 which is located downstream of the second monitoring device 12 outputs the PWM signal whose duty cycle is set to b3%.

The fourth monitoring device 12 (i.e., the last monitoring device 12) which is located downstream of the third monitoring device 12 outputs the PWM signal whose duty cycle is set to b4%.

The duty cycle b4% of the PWM signal outputted from the fourth monitoring device 12 is then inputted to the battery ECU 20. For instance, the duty cycle b0% is 60%. The duty cycle b1% is 56%. The duty cycle b2% is 52%. The duty cycle b3% is 48%. The duty cycle b4% is 44%.

Each of the monitoring devices 12 analyzes the duty cycle (i.e., one of b0% to b3%) of the PWM signal inputted thereto to detect its own module ID and stores it in the memory thereof. Specifically, ID1, ID2, ID3, and ID4 are assigned as the module IDs to the duty cycles b0%, b1%, b2%, and b3% of the PWM signals. Each of the monitoring devices 12 derives a corresponding one of the module ID1, ID2, ID3, and ID4 in relation to the duty cycle b0%, b1%, b2%, or b3% of the PWM signal inputted thereto and sets the communication ID in relation to the module ID assigned thereto.

When receiving the PWM signal from the fourth monitoring device 12 and detecting the fact that the duty cycle of the received PWM signal is b4%, the battery ECU 20 determines that the setting of the module IDs of all the monitoring devices 12 has been completed. The battery ECU 20 also determines that the ID1 to ID4 have been assigned to the battery modules 10 in the form of the module IDs.

in the final step of the DI setting task demonstrated in FIG. 5(c), the battery ECU 20 sends an ID setting completion signal to each of the monitoring devices 12 using the CAN communication line 21. This causes each of the monitoring devices 12 to cancel the standby state in which the ID setting is performed and enter an operable state.

In this embodiment, upon start-up of the battery ECU 20, the battery ECU 20 verifies the communication ID assigned to the monitoring device 12 of each of the battery modules 10 and then analyzes a result of the verification to determine whether communication with a corresponding one of the monitoring devices 12 has been established. When such communication is determined to have not been established, the battery ECU 20 performs a module ID setting task (which will also be referred to below as a first setting task). In a case where the battery modules 10 have been replaced with charged ones immediately before the battery ECU 20 is currently started, the communication IDs of the battery modules 10 are not yet been set, in other words, have default values, thereby resulting in a failure in properly verifying the communication IDs. The battery ECU 20, thus, determines that no communications with the battery modules 10 are established and then commences the module ID setting task. Each of the monitoring devices 12 may be designed not to output or receive the communication ID when it is initialized.

The battery ECU 20 also performs a second setting task in addition to the above-described first setting task. The second setting task is a task to determine whether each of the battery modules 10 has been replaced with a charged one, in other words, each of the battery modules 10 has been removed from the vehicle 40 and the replacement battery module 10 has been installed in the vehicle 40 at least after a corresponding one of the module IDs was set from the default value at the first time, the battery ECU 20 determines whether the battery module(s) 10 has been replaced, that is, removed from the vehicle 40 and the replacement battery module(s) 10 has been installed in the vehicle 40. When the battery module(s) 10 is determined to have been replaced, the battery ECU 20 sets the module ID(s) of the replacement battery module(s) 10.

The second setting task is to directly detect replacement of the battery module(s) 10 with the replacement battery module(s) 10 and analyze such an event (i.e., a replacement record) to set or assign the module ID(s) to the replacement battery module(s) 10. Usually, the replacement of the battery module(s) 10 (i.e., battery re-installation) is performed when an ignition switch of the vehicle 40 is in an off-state where the vehicle 40 is stopped or parked, in other words, the battery ECU 20 is at rest. The monitoring device 12 of each of the battery modules 10 is designed to be activated in response to application of a power supply voltage thereto upon installation on the rack 41, i.e., connection of the module-connector 14 with the rack-connector 43. Therefore, when the battery ECU 20 is turned on in response to the activation of the monitoring devices 12 of the battery modules 10 upon installation of the battery modules 10 on the rack 41 in the off-state of the ignition switch, the battery ECU 20 determines that the battery modules 10 have been re-installed in the vehicle 40.

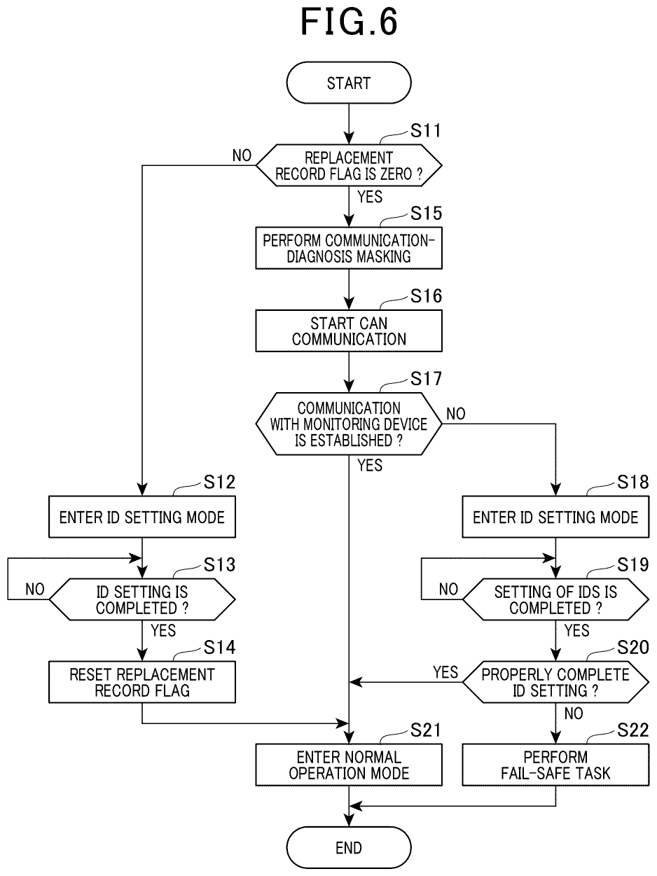

FIG. 6 is a flowchart of a sequence of steps of an ID setting task to set each of the module IDs. This task is performed by the battery ECU 20.

After entering the program in FIG. 6, the routine proceeds to step S11 wherein it is determined whether a value of replacement record flag which indicates that the battery module(s) 10 has been replaced with a charged one(s) is zero. When the battery module(s) 10 remains unreplaced, it will cause the replacement record flag to be zero. A YES answer is, thus, obtained in step S11. Alternatively, if the battery module(s) 10 has been replaced, the replacement record flag is one. A NO answer is, thus, obtained in step S11.

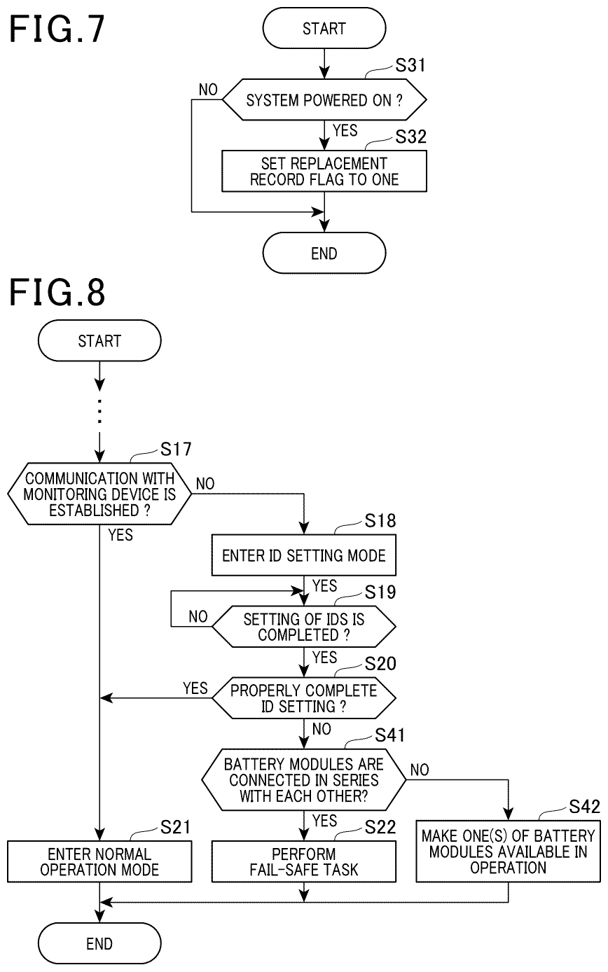

A setting task for setting each of the replacement record flag will be described below with reference to a flowchart of FIG. 7. The setting task is performed upon start of the battery ECU 20.

First, in step S31, it is determined whether the current start-up of the battery ECU 20 is a start-up initiated by activation of the monitoring devices 12 in response to installation of the battery module(s) 10 in the vehicle 40 (which will also be referred to below as system start-up from shutdown). If a YES answer is obtained meaning that the system start-up from shutdown has been performed, then the routine proceeds to step S32 wherein it is determined that the battery module(s) 10 has been replaced, and the replacement record flag is set to one. Alternatively, if a NO answer is obtained meaning that no system start-up from shutdown is performed, the replacement record flag is kept zero.

Referring back to FIG. 6, if a NO answer is obtained in step S11 meaning that the replacement record flag is one, then the routine proceeds to step S12 wherein an operation mode of the battery EUC 20 enters an ID setting mode to update or set the module IDs. Specifically, the fact that the replacement record flag is one means that the battery ECU 20 directly detects the fact that at least one of the battery modules 10 has been replaced or re-installed. The battery ECU 20 initiate setting of the module IDs. Specifically, when the ID setting mode is entered, the module ID of each of the battery modules 10 is, as described above, set in response to the PWM signal outputted from the battery ECU 20 in the way demonstrated in FIGS. 5(a) to 5(c).

The routine proceeds to step S13 wherein it is determined whether the setting of the module IDs is completed. If a NO answer is obtained, then the routine repeats the operation in step S13. Alternatively, if a YES answer is obtained meaning that the setting of the module IDs is completed, then the routine proceeds to step S14 wherein the replacement record flag is reset to zero. The routine then proceeds to step S21 wherein a usual or normal operation mode is entered from ID setting mode.

If a YES answer is obtained in step S11 meaning the replacement record flag is zero, then the routine proceeds to step S15 wherein a communication-diagnosis masking is performed. The communication-diagnosis masking is a strategy which, when a diagnosis is performed, and no failure is determined to have occurred in communication with each of the monitoring devices 12, suspends or avoid such a determination. Afterwords, the routine proceeds to step S16 wherein the CAN communication with each of the monitoring devices 12 is commenced.

The routine proceeds to step S17 wherein it is determined whether communication with the monitoring device 12 of each of the battery modules 10 is established. Specifically, the battery ECU 20 checks or matches the communication ID received from each of the monitoring devices 12 through the communication line 21 against that recognized by the battery ECU 20 and analyzes such a result to determine whether the communication with each of the monitoring devices 12 is now properly established. When at least one of the battery modules 10 has been replaced with a charged one immediately before the battery ECU 20 is currently powered on, it represents that there is at least one of the monitoring devices 12 whose communication ID is unmatched with that recognized by the battery ECU 20. The battery ECU 20 determines that the communication with the monitoring device(s) 12 is not properly established. This determination may be made using the fact that the communication ID of the monitoring device(s) 12 is set to a default value.

If a NO answer is obtained in step S17 meaning that the communications with none of the monitoring devices 12 are established, then the routine proceeds to step S18 wherein the ID setting mode is entered. The current operation mode is, as described above, the communication-diagnosis masking mode. The determination that there is a failure in communicating with each of the monitoring devices 12 is, therefore, suspended.

If a YES answer is obtained in step S17 meaning that the communications with all the monitoring devices 12 are established, then the routine proceeds to step S21 wherein the normal operation mode is entered. Specifically, when the communications with all the monitoring devices 12 are established upon power-on of the battery ECU 20, a given control task is commenced in the normal operation mode. In step S21, the communication-diagnosis masking mode is cancelled.

In step S18, the module IDs are set in the ID setting mode. Specifically, the module ID of each of the battery modules 10 is set in response to the PWM signal which is, as described above, outputted from the battery ECU 20 upon entrance of the ID setting mode (see FIGS. 5(a) to 5(c)).

After step S18, the routine proceeds to step S19 wherein it is determined whether the setting of the module IDs is completed. If a YES answer is obtained, then the routine proceeds to step S20.

In step S20, it is determined whether the setting of the module IDs is properly completed in the ID setting mode. Specifically, when the communication between the battery ECU 20 with each of the monitoring devices 12 is not established, such a failure may be caused by a difficulty in communication, such as a malfunction of a communication device or faulty connections of communication connectors in addition to the initialization of the module IDs upon replacement of the battery module(s) 10. Accordingly, the difficulty in communication may result in a failure in performing the above sequence of ID setting steps, which will lead to a risk that the module IDs may incorrectly set.

In step S19, when the sequence of ID setting steps is completed or a predetermined period of time in which the sequence of ID setting steps are performed expires, the routine proceeds to step S20 regardless of whether the module IDs are properly set.

In step S20, it is determined whether the module IDs have been properly set. If a YES answer is obtained meaning that the communication with each of the monitoring devices 12 is properly established, then the routine proceeds to step S21 wherein the ID setting mode is terminated, and the normal operation mode is entered. In step S21, the communication-diagnosis masking is also cancelled.

If a NO answer is obtained in step S20 meaning that the module IDs are not properly set, then the routine proceeds to step S22 wherein it is determined that a failure has occurred in communication with the monitoring devices 12, and a given fail-safe task is performed. For example, the battery ECU 20 performs the fail-safe task to output a warning signal to urge a user or driver of the vehicle 40 to check states of installation of the battery modules 10. In a case where non-establishment of the communication between the battery ECU 20 with each of the monitoring devices 12 is caused by occurrence of a fault in such communication, it may arise from incorrect replacement of the battery modules 10 by the user of the vehicle 40. In such an event, the warning signal is, as described above, outputted to the user, thereby enabling the user to correct the non-establishment of communication with the monitoring devices 12 arising from the incorrect replacement of the battery modules 10. In such a case, after the installation of the battery modules 10 in the vehicle 40 is made again, the task in FIG. 6 may be performed again.

The above-described embodiment offers the following beneficial advantages.

The storage battery system in the above embodiment is, as described above, designed to determine whether the battery module(s) 10 has been removed, and then the replacement battery module(s) 10 has been installed in the vehicle 40 and newly set the module IDs of the battery modules 10 again when the replacement battery module(s) 10 is determined to be installed in the vehicle 40. The determination of whether the replacement battery module(s) 10 has been installed which is made by the battery ECU 20 facilitates the ease with which the ID setting mode to set the module IDs is entered quickly after the installation of the battery modules. This makes it easy to produce the identification information for each of the battery modules 10 upon replacement of the battery module(s) 10.

The delivery of power supply voltage (i.e., +B in FIG. 1) to the monitoring devices 12 is achieved by attaching the battery modules 10 to the rack 41 of the vehicle 40. The monitoring devices 12 are then powered on. Detection of a fact that states of the monitoring devices 12 have been changed from power-off states to power-on states enables a determination that the replacement battery modules 10 have been installed in the vehicle 40. The battery ECU 20 is, therefore, capable of detecting activation of the monitoring devices 12 to determine the fact that the replacement battery module(s) 10 has been installed in the vehicle 40, thereby enabling the module IDs to be properly set after the replacement battery module(s) 10 has been installed.

Usually, the replacement of the battery module(s) 10 (i.e., battery re-installation) is performed when the ignition switch of the vehicle 40 is in an off-state where the vehicle 40 is stopped or parked, in other words, the battery ECU 20 is at rest. When the system start-up from shutdown is performed in response to the power-on of the monitoring devices 12 upon installation of the replacement battery module(s) 10 in the off-state of the ignition switch, the battery ECU 20 determines that the replacement battery module(s) 10 has been installed in the vehicle 40. This enables the module ID of each of the battery modules 10 to be properly set even in the off-state of the ignition switch.

The setting of the module IDs is achieved in this embodiment by when one of a first condition and a second condition is met upon the power-on of the battery ECU 20. The first condition is a condition where the replacement battery module(s) 10 has been installed in the vehicle 40. The second condition is a condition where communication with the monitoring device(s) 12 is not established. The result of the logical disjunction between the first and second conditions is used to determine that the battery module(s) 10 has been replaced with another, thereby enabling the ID setting mode to be entered properly after the replacement of the battery module(s) 10, which ensures the stability in properly setting the module IDs. For instance, the storage battery system in this embodiment is capable of eliminating a risk that the condition required to enter the ID setting mode is not satisfied after replacement of the battery module(s) 10, thereby resulting in the module IDs remaining unset which may undesirably affect the driving of the vehicle 40.

### Second Embodiment

The second embodiment will be described below in terms of differences between itself and the first embodiment.

The second embodiment is different from the first embodiment in that one(s) of the battery modules 10 whose module ID is not correctly set in the ID setting mode is made inoperable, while the remaining battery modules 10 are made operable in a condition where the battery modules 10 are connected in parallel to each other.

FIG. 8 is a flowchart of a sequence of steps or program to set the module IDs. This program is executed instead of that illustrated in FIG. 6. The program in FIG. 8 is partly different from that in FIG. 6. The same operations as those in FIG. 6 are indicated by the same step numbers, and explanation thereof in detail will be omitted here.

In the flowchart illustrated in FIG. 8, if a NO answer is obtained in step S17 meaning that communication with the monitoring device 12 of each of the battery modules 10 is not properly established, then the routine proceeds to steps S18 and S19 wherein the module IDs are set in the ID setting mode. The routine proceeds to step S20 wherein it is determined whether the module IDs have been properly set. If a NO answer is obtained in step S20, then the routine proceeds to step S41 wherein it is determined whether the battery packs 11 of the battery modules 10 in the storage battery system are electrically connected in series with each other. If a YES answer is obtained meaning that the battery packs 11 of the battery modules 10 are connected in series with each other in the way illustrated in FIG. 2(a), then the routine proceeds to step S22 wherein the given fail-safe task is performed to output a warning signal to urge the user or driver of the vehicle 40 to check states of installation of the battery modules 10.

If a NO answer is obtained in step S41 meaning that the battery packs 11 of the battery modules 10 are electrically connected in parallel to each other in the way demonstrated in FIG. 2(b), then the routine proceeds to step S42 wherein an individual of the battery modules 10 whose module ID has not been properly set is made inoperable in operation, while the remaining battery module(s) 10 are made operable in operation. Usually, when one or a subset of the battery modules 10 is made inoperable, the vehicle 40 is properly enabled to be moved. The remaining battery module(s) 10 may, therefore, be used to drive the vehicle 40 without use of the battery module(s) 10 whose module ID has not been properly set. The fail-safe task in step S22 will also be referred to as a first fail-safe task. The failure-safe task in step S42 will also be referred to as a second fail-safe task.

The storage battery system in the second embodiment is, as described above, designed to make inoperable one(s) of the battery modules 10 whose module ID is not properly set and also make operable the remaining battery module(s) 10 in the condition where combinations of the battery packs 11 of the battery modules 10 are electrically connected in parallel to each other. This enables the vehicle 40 to move immediately after the battery module(s) 10 is replaced even when one or a subset of the module IDs of the battery modules 10 is not properly set.

### Other Embodiments

The above-described embodiments may be modified in the following ways.

The module IDs may be set using a re-installation record which indicates the fact that one(s) of the battery modules 10 has been replaced, i.e., re-installed in the vehicle 40. The setting of the module IDs is performed in an ID setting task (which will be referred to as a second setting task) discussed below.

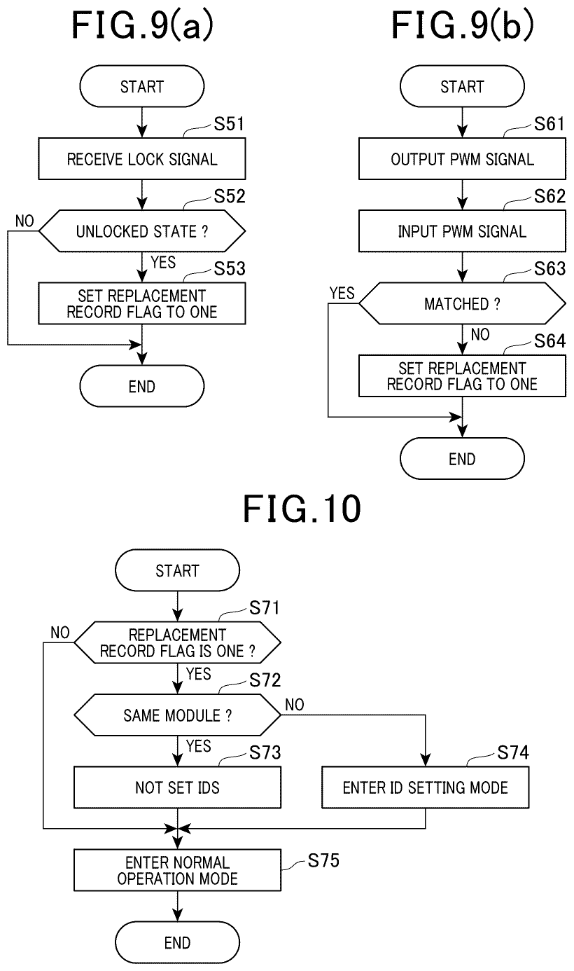

FIG. 9(a) illustrates the second setting task to use a lock signal outputted from each of the locking devices 50 installed in the rack 41 to determine whether a corresponding one of the battery modules 10 has been replaced with a charged one (i.e., the replacement battery module 10). Specifically, in step S51, the battery ECU 20 receives the lock signal outputted from each of the locking devices 50. The routine proceeds to step S52 wherein the lock signal is analyzed to determine whether a corresponding one of the locking devices 50 has been changed from the locked state to the unlocked state. If a YES answer is obtained meaning that a corresponding one of the locking devices 50 has been changed from the locked state to the unlocked state, then the routine proceeds to step S53 wherein the replacement record flat is set to one. Alternatively, when each of the locking devices 50 is determined to have been changed from the unlocked state to the locked state, the replacement record flag may be set to one.

Usually, each time each of the battery modules 10 is replaced with a charged one, a corresponding one of the locking devices 50 installed in the rack 41 is unlocked and then locked. Therefore, when one of the locking devices 50 is determined to have been changed from one of the locked state and the unlocked state to another, a corresponding one of the battery modules 10 is determined to have been re-installed, i.e., replaced. This facilitates detection of a fact that one(s) of the battery modules 10 has been replaced with a charged one.

FIG. 9(b) illustrates another example of the second setting task which is used with a structure in which the monitoring devices 12 of the battery modules 10 are electrically connected in series with each other using a series-connection line(s) and analyzes a signal inputted to the series-connection line and a signal outputted from the series-connection line to determine whether each of the battery modules 10 has been re-installed, i.e., replaced with a charged one. The series-connection line(s) include, for example, the PWM communication line 22 illustrated in FIG. 1. Specifically, when the ignition switch of the vehicle 40 is in the off-state, the battery ECU 20 is activated in a given cycle to input the PWM signal having a predetermined duty cycle to the PWM communication line 22. The PWM signal is then returned back to the battery ECU 20 through each of the monitoring devices 12.

In step S61 in FIG. 9(b), the battery ECU 20 outputs the PWM signal (which will also be referred to below as a first PWM signal) to an upstream one of the series-connected monitoring devices 12 (i.e., the first monitoring device 12 to which the PWM signal is inputted directly from the battery ECU 20) using the PWM communication line 22. In step S62, the PWM signal (which will also be referred to below as a second PWM signal) is also inputted from a downstream one of the series-connected monitoring devices 12 (i.e., the second monitoring device 12 located farthest away from the first monitoring devices 12) to the battery ECU 20 substantially at the same time the PWM signal is directly inputted from the battery ECU 20 to the first monitoring device 12. The routine proceeds to step S63 wherein it is determined whether the second PWM signal outputted from the second monitoring device 12 is matched with the first PWM signal inputted directly from the battery ECU 20 to the first monitoring device 12. If a NO answer is obtained meaning that the second PWM signal is not identical with the first PWM signal, then the routine proceeds to step S64 wherein the replacement record flag set to one.

The series-connection line may not include the PWM communication line 22. For instance, a connection line is prepared which electrically connects the monitoring devices 12 in series with each other between an input terminal and an output terminal of the battery ECU 20. The battery ECU 20 outputs from the output terminal thereof a voltage signal having a given voltage level higher than a predetermined threshold to the first monitoring device 12 using the connection line. When none of the battery modules 10 is replaced with a charged one, the battery ECU 20 will have inputted to the input terminal thereof a voltage signal which has a volage level higher than the predetermined threshold. When one(s) of the battery modules 10 has been removed from the vehicle 40 and then replaced with a charged one, it causes a voltage signal whose voltage level is, for example, zero (i.e., lower than the predetermined threshold) to be inputted to the battery ECU 20. In such a case, the battery ECU 20 determines that the second PWM signal is unmatched with the first PWM signal and detects the fact that at least one of the battery modules 10 has been replaced.

Specifically, when at least one of the battery modules 10 has been replaced, it will cause the signal inputted to the series-connection line (e.g., the PWM communication line 22) to be cut in the one of the battery modules 10. This signal cut cause a relation in, for example, voltage level between the signals outputted from and inputted to the battery ECU 20 to be different from that when the signal inputted from the battery ECU 20 to the series-connection line is returned back to the battery ECU 20 without being cut. Using such a fact, the battery ECU 20 analyzes the signals inputted to and outputted from the series-connection line to determine whether one(s) of the battery modules 10 has been re-installed or replaced with a charged one.

Each of the above embodiment is capable of establishing a communication between the battery ECU 20 and the monitoring device 12 of each of the battery modules 10 using the CAN communication line, but however, each of the embodiments may alternatively be designed to achieve a radio or wireless communication between the battery ECU 20 and each of the monitoring devices 12. In such a case, information about activation or power-on of each of the monitoring devices 12 using the power supply +B (i.e., battery voltage) and/or a record indicating replacement of each of the battery modules 10 may be transmitted to the battery ECU 20 in a wireless mode.

Usually, after the battery modules 10 are removed from the rack 41 of the vehicle 40, the replacement battery modules 10 are mounted on the rack 41, or alternatively the removed battery modules 10 are recharged and then installed on the rack 41 again. The ID setting task may be altered depending on whether the replacement battery modules 10 are mounted in the vehicle 40 or the battery modules 10 are mounted in the vehicle 40 after electrically re-charged.

Specifically, upon start-up of the battery ECU 20, a program illustrated in FIG. 10 may be executed by the battery ECU 20. After entering the program, the routine proceeds to step S71 wherein it is determined whether the replacement record flag is one. If a YES answer is obtained, then the routine proceeds to step S72 wherein it is determined whether the battery modules 10 currently installed in the vehicle 40 are the same as those removed immediately before. The determination of whether the currently installed battery modules 10 are identical with those removed previously may be made by the battery ECU 20 using an operator's input. For instance, the vehicle 40 asks the operator whether the battery modules 10 intended to be installed in the vehicle 40 are the same as those removed previously during a replacement working of the operator. The operator answers such an inquiry in the form of an input to the battery ECU 20. The battery ECU 20 analyzes the operator's input to determine whether the currently installed battery modules 10 are the same as those removed previously. Alternatively, the monitoring device 12 of each of the battery modules 10 may store an ID record therein. The battery ECU 20 may analyze the ID record of each of the battery modules 10 and determine whether the currently installed battery modules 10 are the same as those removed previously. In a case where the battery modules 10 are installed again in the vehicle 40 after electrically re-charged using an external charger, it is preferable not to initialize the identifying information (i.e., the module IDs and the communication IDs) on the monitoring devices 12 during the re-charging operation. This causes the ECU 20 to recognize the same identifying information as that before the battery modules 10 are removed when the ECU 20 is started-up immediately after the battery modules 10 are installed in the vehicle 40 again.

If a YES answer is obtained in step S72 meaning that the currently installed battery modules 10 are the same as those removed previously, then the routine proceeds to step S73 wherein the module IDs are not updated, i.e., not assigned to the battery modules 10 again. Alternatively, if a NO answer is obtained in step S72 meaning that the currently installed battery modules 10 are different from those removed previously, then the routine proceeds to step S74 wherein the ID setting mode is entered to update the module IDs, in other words, newly assign module IDs to the battery modules 10. After step S73 or S74, the routine proceeds to step S75 wherein the normal operation mode is entered.

The case where the currently installed battery modules 10 are the same as those removed previously may include a case where the battery modules 10 are installed again in the vehicle 40 without electrically re-charged or a case where the battery modules 10 are installed again in the vehicle 40 after electrically re-charged. The former case may include a case where the battery modules 10 are temporarily removed from the vehicle 40 for inspection. In such an event, the module IDs are not updated, that is, the same module IDs are used for the currently installed battery modules 10. When the battery modules 10 are installed again in the vehicle 40 after electrically re-charged, the module IDs may be updated for the battery modules 10.

When the battery module(s) 10 is determined to be installed again in the vehicle 40, a mode of setting the ID(s) is changed depending on whether the currently installed battery module(s) 10 is the same as that removed previously. This achieves a suitable setting of the ID(s) depending on whether a resetting of the module ID(s) is required.

The vehicle 40 has a possibility that at least two of the battery modules 10 may be changed or reversed in location in the rack 41 without changing a combination of the battery modules 10. In such an event, the battery ECU 20 may analyze the ID records of the monitoring devices 12 to determine whether re-installation of the battery modules 10 arises merely from reversing of locations thereof in the rack 41. In this case, the module IDs may be used as they are without resetting them.

Each of the above-described embodiments works to set the identifying information for each of the battery modules 10 using the PWM signal outputted from the battery ECU 20 to the monitoring devices 12, but however, it may be designed to set the identifying information in another way. For instance, the storage battery system may alternatively be designed to have the monitoring devices 12 connected in series with each other, apply a predetermined level of voltage to an upstream one (i.e., the first monitoring device 12) of the monitoring devices 12 in a series-connected arrangement thereof, and set module IDs in sequence from the upstream one to a downstream one (i.e., the second monitoring device 12) of the monitoring devices 12.

The storage battery system in each of the above-described embodiments is, as described above, operable to perform the first and second setting tasks upon start-up of the battery ECU 20. The first setting task is performed when communication of the battery ECU 20 with none of the monitoring devices 12 is established, while the second setting task is performed using a record indicating the fact that the battery module(s) 10 has been re-installed in the vehicle 40. The batter storage system may alternatively be designed to perform only one of the first setting task (i.e., steps S11 to S14, and S21 in FIG. 6) and the second setting task (i.e., steps S15 to S22 in FIG. 6).

In the second setting task, when the monitoring devices 12 are powered on upon re-installation of the battery modules 10 in the vehicle 40, in other words, turned on by the power supply +B, the replacement record flat may be set in each of the monitoring devices 12 and then outputted from the monitoring devices 12 to the battery ECU 20.

The storage battery system in the above embodiments uses the battery ECU 20 as an identifying information setting device, but however, it may alternatively be designed to have an identifying information setting device in addition to the battery ECU 20. For instance, the storage battery system may include, as the identifying information setting device, a provisioning device working to set or produce IDs for the battery modules 10.

The above-described embodiments refer to the storage battery system designed for automotive vehicles, but however, may alternatively be used with aircrafts, ships, or boats other than automotive vehicles. The storage battery system may alternatively be mounted on a stationary place. For instance, the storage battery system (i.e., the identifying information setting apparatus) may be associated with houses, shops, stores, or utility plants. The identifying information setting apparatus may also be employed to set IDs of the battery modules 10 installed in a storage battery system.

The rack 41 for the battery modules 10 may be made of a housing with an open wall and an openable door attached to the open wall. The housing has formed therein a plurality of rack chambers with shelves in which the battery modules 10 are mounted. In the housing, the monitoring devices 12 of the battery modules 10 may be wirelessly communicable with each other. The housing may be equipped with a heat dissipator, such as a vent hole or a liquid coolant system, The housing or the door may also be equipped with a waveguide and/or a radio-wave absorber.

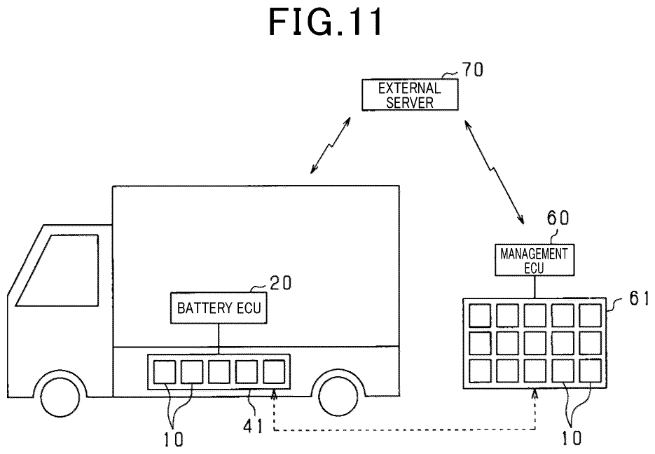

Each of the above embodiments may alternatively be designed to include a first storage battery system configured only to use electricity stored in the battery modules 10 and a second storage battery system configured only to store the battery modules 10. The battery modules 10 are exchangeable between the first storage battery system and the second storage battery system. This system may be realized to include a structure illustrated in FIG. 11. FIG. 11 is a schematic view which illustrates an in-vehicle storage battery system designed as the first storage battery system including a first set of battery modules 10 and the battery ECU 20 and a battery storage system designed as the second storage battery system including a second set of the battery modules 10 and the management ECU 60. The battery storage system includes the rack 61 serving as a module holder in which the battery modules 10 are mounted. Although not illustrated, the rack 61 is, like the rack 41, equipped with rack-connectors and locking devices. The battery modules 10 disposed in the racks 41 and 61 may be swapped between the first and second storage battery systems.

The in-vehicle storage battery system and the battery storage system may be different therebetween in number of the battery modules 10 mounted in the rack 41 and the rack 61. For instance, it is advisable that the number of the battery modules 10 stored in the battery storage system be greater than that in the in-vehicle storage battery system. The rack 61 may have stored therein a plurality of groups of the battery modules 10 which are assigned, one group to each of a plurality of vehicles. The in-vehicle storage battery system and the battery storage system may be identical in number of the battery modules 10 in the racks 41 and 61 with each other.

When the battery modules 10 are swapped between the racks 41 sand 61, the battery ECU 20 updates or newly sets IDs of the battery modules 10 in the rack 41 in the same way as described above. Similarly, the management ECU 60 updates or newly sets IDs of the battery modules 10 in the rack 60 in the same way as described above. Specifically, the ECUs 20 and 60 have communication devices identical in communication format with each other. Each time the battery modules 10 are re-installed in the in-vehicle storage battery system or the battery storage system, the ECU 20 or 60 sets IDs (i.e., the module IDs) of the battery modules 10 in the above-described way.

When detecting the fact that the battery modules 10 have been swapped between the racks 41 and 61, each of the ECUs 20 and 60 may visually or acoustically inform an operator(s) of such a fact using a display or voice. The module IDs may be used to inform which of the battery modules 10 have been swapped between the racks 41 and 61. This enables the operator(s) to detect the fact that the ECUs 20 and 60 properly recognize the swapping or exchanging of the battery modules 10. If the battery modules 10 have been swapped illegally or wrongly, the above system may be used to notify the operator(s) of such a wrongful act. In other words, the ID setting system referred to in this disclosure may be used as a security system for the battery modules 10.

The battery storage system has a risk that the long-term storage of the battery modules 10 may result in self-discharge of the battery modules 10 which reduces an amount of electrical energy stored therein or aging of the battery modules 10 which shortens service lives thereof. It is, therefore, preferable for the management ECU 60 to monitor the states of the battery modules 10 stored in the rack 61. The management ECU 60 preferably works to activate the monitoring devices 12 of the battery modules 10 on a routine schedule.

It is possible to identify locations of the battery modules 10 in the rack 61 as long as the module IDs are assigned to the battery modules 10. This facilitates the ease of determination of which of the battery modules 10 has undergone a reduction in stored among of electrical energy or aging in the battery storage system, thereby improving the maintenance of the battery modules 10. The battery storage system may be designed to be capable of electrically charging the battery modules 10 installed in the rack 61. The battery storage system may also be designed to be capable of selecting a required one of the battery modules 10 and electrically charging it.

Each of the ECUs 20 and 60 is wirelessly communicable with the external server 70. When detecting swapping of the battery modules 10 between the racks 41 and 61, each of the ECUs 20 and 60 may notify the external server 70 of such an event. This facilitates proper management of swapping of the battery modules 10 between the in-vehicle storage battery system and the battery storage system.

The system illustrated in FIG. 11 is, as apparent from the above discussion, capable of exchanging the battery modules 10 between the in-vehicle storage battery system and the battery storage system and updating or setting the modules IDs in the way identical therebetween. This achieves proper setting of the module IDs either when the battery modules 10 are in use or stored in the rack 41 or 61, thereby ensuring the stability in continuous management of the battery modules 10.

The controllers or how to construct them referred to in this disclosure may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

The above embodiments realize the following unique structures.

### First Structure

An identifying information setting apparatus is provided which is used in a storage battery system which includes a plurality of battery modules each of which has a battery and a monitoring device working to supervise the battery, the identifying information setting apparatus being capable of communicating with each of the monitoring devices and setting module identifying information for each of the battery modules. The identifying information setting apparatus comprises: (a) an installation determiner which is configured to determine whether each of the battery modules has been re-installed, which includes removal of a corresponding one of the battery modules and re-mounting thereof or exchanging with a replacement battery module in the storage battery system; and (b) an identifying information setting unit which is configured to set the module identifying information for each of the battery modules when at least one of the battery modules is determined by the installation determiner to have been re-installed.

### Second Structure

The identifying information setting apparatus, as set forth in the first structure, wherein the storage battery system is equipped with a module holder in which the battery modules are removably installed. The monitoring devices are applied with a power supply voltage in response to installation of the battery modules in the module holder, while the application of the power supply voltage to the monitoring devices is cut in response to removal of the battery modules from the module holder. The monitoring devices are activated by the application of the power supply volage thereto in response to the installation of the battery modules in the module holder. In response to a change from the cut of the power supply volage from the monitoring devices to the application of the power supply voltage to the monitoring devices, the installation determiner determines that the battery module(s) has been re-installed.

### Third Structure

The identifying information setting apparatus, as set forth in the second structure, wherein when the monitoring devices start to be activated in response to installation of the battery modules in the module holder in an off-state of the storage battery system, the identifying information setting apparatus is started up from shutdown in response to activation of the monitoring devices. In response to the start-up from shutdown of the identifying information setting apparatus, the installation determiner determines that the battery module(s) has been re-installed.

### Fourth Structure

The identifying information setting apparatus, as set forth in the first structure, wherein the storage battery system includes a module holder in which the plurality of battery modules are removably installed, the module holder being equipped with lock devices which function to tightly hold the battery modules or make it difficult to remove the battery modules from the module holder. When detecting a fact that the lock devices have been changed from a locked state to an unlocked state or vice versa, the installation determiner determines that the battery modules have been re-installed.

### Fifth Structure

The identifying information setting apparatus, as set forth in the first structure, wherein the storage battery system has the monitoring devices of the battery modules electrically connected in series with each other using a series-connection line. The installation determiner uses an input signal inputted to the series-connection line and an output signal outputted from the series-connection line to determine that the battery module(s) has been re-installed.

### Sixth Structure

The identifying information setting apparatus, as set forth in any one of the first to fifth structure, further comprising an identification determiner which, when the installation determiner determines that the battery module(s) has been re-installed, determines whether the re-installed battery module is same as that removed previously from the storage battery system. The identifying information setting unit works to change a mode to setting the module identifying information depending on whether the re-installed battery module is same as that removed previously from the storage battery system.

### Seventh Structure

The identifying information setting apparatus, as set forth in any one of the first to sixth structure, further comprising a communication determiner which checks a communication identification assigned to each of the monitoring devices to determine whether communication with a corresponding one of the monitoring devices is established. When at least one of a condition where the installation determiner determines that the battery module(s) has been re-installed and a condition where the communication determiner determines the communication with each of the monitoring devices is not established is met upon start-up of the identifying information setting apparatus, the identifying information setting unit works to set the module identifying information.

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

1. An identifying information setting apparatus for use in a storage battery system which includes a plurality of battery modules each of which has a battery and a monitoring device working to supervise the battery, the identifying information setting apparatus being capable of communicating with each of the monitoring devices and setting module identifying information for each of the battery modules, comprising:
an installation determiner which is configured to determine whether each of the battery modules has been re-installed, which includes removal of a corresponding one of the battery modules and re-mounting thereof or exchanging with a replacement battery module in the storage battery system; and
an identifying information setting unit which is configured to set the module identifying information for each of the battery modules when the battery module(s) is determined by the installation determiner to have been re-installed.

2. The identifying information setting apparatus, as set forth in claim 1, wherein the storage battery system is equipped with a module holder in which the battery modules are removably installed,
the monitoring devices are applied with a power supply voltage in response to installation of the battery modules in the module holder, while application of the power supply voltage to the monitoring devices is cut in response to removal of the battery modules from the module holder,
the monitoring devices are activated by the application of the power supply volage thereto in response to the installation of the battery modules in the module holder, and
in response to a change from cut of the power supply volage from the monitoring devices to application of the power supply voltage to the monitoring devices, the installation determiner determines that the battery module(s) has been re-installed.

3. The identifying information setting apparatus, as set forth in claim 2, wherein when the monitoring devices start to be activated in response to installation of the battery modules in the module holder in an off-state of the storage battery system, the identifying information setting apparatus is started up from shutdown in response to activation of the monitoring devices, and
In response to start-up from shutdown of the identifying information setting apparatus, the installation determiner determines that the battery module(s) has been re-installed.

4. The identifying information setting apparatus, as set forth in claim 1, wherein the storage battery system includes a module holder in which the plurality of battery modules are removably installed, the module holder being equipped with lock devices which function to tightly hold the battery modules or make it difficult to remove the battery modules from the module holder, and
when detecting a fact that the lock devices have been changed from a locked state to an unlocked state or vice versa, the installation determiner determines that the battery modules have been re-installed.

5. The identifying information setting apparatus, as set forth in claim 1, wherein the storage battery system has the monitoring devices of the battery modules electrically connected in series with each other using a series-connection line, and
the installation determiner uses an input signal inputted to the series-connection line and an output signal outputted from the series-connection line to determine that the battery module(s) has been re-installed.

6. The identifying information setting apparatus, as set forth in claim 1, further comprising an identification determiner which, when the installation determiner determines that the battery module(s) has been re-installed, determines whether the re-installed battery module is same as that removed previously from the storage battery system, and wherein
the identifying information setting unit works to change a mode to setting the module identifying information depending on whether the re-installed battery module is same as that removed previously from the storage battery system.

7. The identifying information setting apparatus, as set forth in claim 1, further comprising a communication determiner which checks a communication identification assigned to each of the monitoring devices to determine whether communication with a corresponding one of the monitoring devices is established, and wherein
when at least one of a condition where the installation determiner determines that the battery module(s) has been re-installed and a condition where the communication determiner determines the communication with each of the monitoring devices is not established is met upon start-up of the identifying information setting apparatus, the identifying information setting unit works to set the module identifying information.

8. A program which is executable by an identifying information setting apparatus for use in a storage battery system which includes a plurality of battery modules each of which has a battery and a monitoring device working to supervise the battery, the identifying information setting apparatus being capable of communicating with each of the monitoring devices and setting module identifying information for each of the battery modules, comprising:
an installation determining step of determining whether each of the battery modules has been re-installed, which includes removal of a corresponding one of the battery modules and re-mounting thereof or exchanging with a replacement battery module in the storage battery system; and
an identifying information setting step which sets the module identifying information for each of the battery modules when the battery module(s) is determined by the installation determiner to have been re-installed.
